(19) United States
(12) Patent Application Publication
(10) Pub. No.: US 2003/0037636 A1
(43) Pub. Date: Feb. 27, 2003

(54) Rotor and rotary machine

(76) Inventors: Takeshi Kawata, Kariya-shi (JP); Masahiro Kawaguchi, Kariya-shi (JP); Masaki Ota, Kariya-shi (JP); Taku Adaniya, Kariya-shi (JP); Tomoharu Arai, Kariya-shi (JP); Akihito Yamanouchi, Kariya-shi (JP); Akinobu Kanai, Kariya-shi (JP); Takahiro Suzuki, Kariya-shi (JP)

Correspondence Address: MORGAN & FINNEGAN, L.L.P., 345 Park Avenue, New York, NY, 10154, US

(21) Appl. No.: 10/227,561

(22) Filed: Aug. 23, 2002

(30) Foreign Application Priority Data
Aug. 23, 2001 (JP) 2001-252493

(51) Int. Cl. F16F 15/10

(52) U.S. Cl. 74/574

(57) ABSTRACT

A rotor is connected to a main body of a rotary machine. The rotor includes a rotor main body and a dynamic damper provided in the rotor main body. The rotor main body is made of resin. The dynamic damper has a weight that swings like a pendulum. The axis of the pendulum motion of the weight is separated by a predetermined distance from and is substantially parallel to the rotation axis of the rotor. This suppresses rotational vibration and reduces noise.

### BACKGROUND OF THE INVENTION

The present invention relates to a rotor and a rotary machine having the rotor.

Typically, a damper mechanism is employed for reducing torque fluctuations in a rotary shaft of a rotary machine, thereby preventing resonance. Such a damper mechanism is coupled, for example, to the output shaft of a drive source such as an engine or to the input shaft of a driven rotational apparatus such as a compressor. When used in a compressor, a damper mechanism is generally coupled to a rotary shaft of the compressor, which is coupled to an engine through rotors such as a hub and a pulley. Also, a certain type of damper mechanism is located in a hub or a pulley.

In the dynamic damper disclosed in Japanese Laid-Open Patent Publication No. 2000-274489, each of roller weights reciprocates along a cylindrical path.

The weight is accommodated in a weight receptacle (accommodation chamber) formed in the rotor. Part of the inner surface of the weight receptacle is formed as a part of the inner surface of a cylinder. The center of curvature of the cylinder is an axis that is spaced from the rotation axis of the rotor by a predetermined distance and is parallel to the rotation axis of the rotor. When the rotor rotates, centrifugal force presses the weight against the cylinder inner surface. In this state, torque fluctuations of the rotary shaft are received by the rotor and swing the weight along the cylinder inner surface.

When the rotational speed of the rotor is too low to generate sufficient centrifugal force to press the weight against the cylinder inner surface, the weight is separated from the cylinder inner surface. As a result, the weight collides with the cylinder inner surface and produces noise. Also, when the torque fluctuation is excessive, amplitude of the pendulum motion of the weight becomes excessive. This hinders the reciprocation of the weight along the cylinder inner surface and separates the weight from the cylinder inner surface. Therefore, as in the case above, the weight collides with the cylinder inner surface and produces noise. Further, when the rotor suddenly starts rotating at a high rate from a stopped state, the weight collides with the cylinder inner surface and produces noise. Typically, the rotor and the weight are made of metal to which no measurement against vibration is applied. For example, metal is used for forming rotors and weights. Therefore, the produced sound is loud.

### SUMMARY OF THE INVENTION

Accordingly, it is an objective of the present invention to provide a rotor body that suppresses rotational vibration and reduces noise. Another objective of the present invention is to provide a rotary machine main body that has such a rotor body.

To achieve the above objective, the present invention provides a rotor connected to a main body of a rotary machine. The rotor includes a rotor main body and a dynamic damper provided in the rotor main body. The rotor main body is made of resin. The dynamic damper has a weight that swings like a pendulum. The axis of the pendulum motion of the weight is separated by a predetermined distance from and is substantially parallel to the rotation axis of the rotor.

The present invention also provides another a rotor which has a rotor main body connected to a main body of a rotary machine. The rotor includes a dynamic damper. The dynamic damper is provided in the rotor main body. The dynamic damper includes an accommodating portion, a weight and a lid. The accommodating portion has a guide surface. A cross-section of the guide surface along a plane perpendicular to the rotation axis of the rotor main body is arcuate. The weight swings like a pendulum. The axis of the pendulum motion of the weight is separated by a predetermined distance from and is substantially parallel to the rotation axis of the rotor. The accommodating portion has an opening to receive the weight. The lid is located on the opening of the accommodating portion. At least a part of at least one of the accommodating portion and the lid is formed with a vibration suppressing metal plate.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view illustrating a compressor having a power transmission mechanism according to a first embodiment of the present invention;

FIG. 2(a) is a schematic front view showing the power transmission mechanism of FIG. 1;

FIG. 2(b) is a cross-sectional view taken along line 2b2b- of FIG. 2(a);

FIG. 3(a) is a partial cross-sectional view illustrating a portion of a rotor according to a second embodiment of the present invention;

FIG. 3(b) is a schematic rear view of the rotor shown in FIG. 3(a);

FIG. 4 is a partial cross-sectional view illustrating a portion of a rotor according to another embodiment; and

FIG. 5 is a partial cross-sectional view illustrating a portion of a rotor according to another embodiment;

FIG. 6 is a partial cross-sectional view illustrating a portion of a rotor according to another embodiment.

### DETAILED DESCRIPTION OF THE PREFERRED EMBODIMENTS

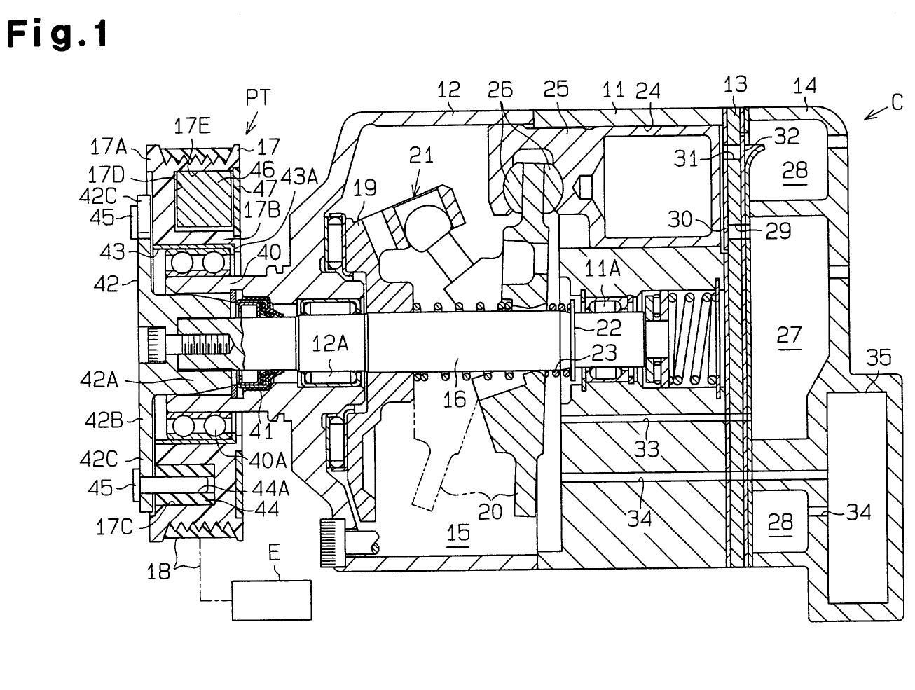

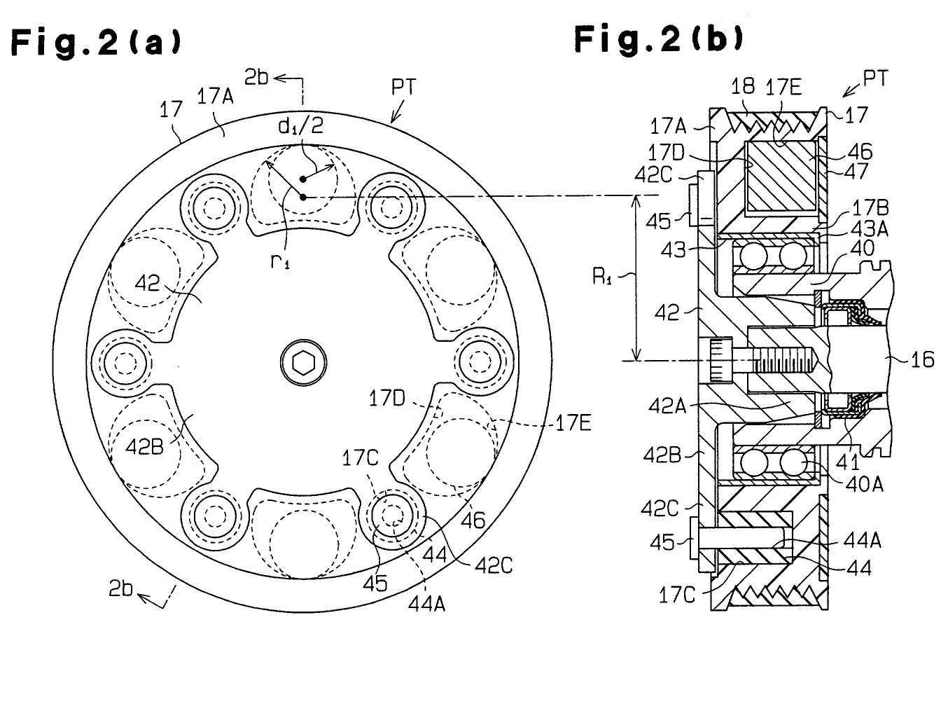

A first embodiment of the present invention will now be described with reference to FIGS. 1 to 2(b). The left end in FIG. 1 is defined as the front of a rotary machine main body C, and the right end is defined as the rear of the rotary machine main body C.

The rotary machine main body C forms a part of a vehicular air conditioner. As shown in FIG. 1, the rotary machine main body C includes a cylinder block 11, a front housing member 12, a valve plate assembly 13, and a rear housing member 14. The front housing member 12 is secured to the front end of the cylinder block 11. The rear housing member 14 is secured to the rear end of the cylinder block 11 with the valve plate assembly 13 in between. In this embodiment, the cylinder block 11, the front housing member 12, and the rear housing member 14 form a housing assembly of the rotary machine main body C.

The cylinder block 11 and the front housing member 12 define a crank chamber 15.

A rotary shaft, which is a drive shaft 16 in this embodiment, extends through the crank chamber 15 and is rotatably supported by the housing. The front portion of the drive shaft 16 is supported by a radial bearing 12A located in the front wall of the front housing member 12. The rear portion of the drive shaft 16 is supported by a radial bearing 11A located in the cylinder block 11.

A cylindrical support 40 is formed at the front end of the front housing member 12. The front end portion of the drive shaft 16 extends through the front wall of the front housing member 12 and is located in the cylindrical support 40. A power transmission mechanism PT is fixed to the front end of the drive shaft 16. The power transmission mechanism PT includes a rotor body, which is a pulley main body 17 in this embodiment. The front end of the drive shaft 16 is coupled to an external drive source, which is a vehicular engine E in this embodiment, by the power transmission mechanism PT and a belt 18, which is hooked with the pulley main body 17. The power transmission mechanism PT and the rotary machine main body C form a rotary machine.

A lug plate 19 is coupled to the drive shaft 16 and is located in the crank chamber 15. The lug plate 19 rotates integrally with the drive shaft 16. A swash plate 20 is accommodated in the crank chamber 15. The swash plate 20 slides along and inclines with respect to the drive shaft 16. A hinge mechanism 21 is arranged between the swash plate 20 and the lug plate 19. The hinge mechanism 21 and the lug plate 19 cause the swash plate 20 to rotate integrally with the drive shaft 16.

A snap ring 22 is fitted about the drive shaft 16. A spring 23 extends between the snap ring 22 and the swash plate 20. The snap ring 22 and the spring 23 limit the minimum inclination angle of the swash plate 20. At the minimum inclination angle of the swash plate 20, the angle defined by the swash plate 20 and the axis of the drive shaft 16 is closest to ninety degrees.

Cylinder bores 24 (only one is shown in FIG. 1) are formed in the cylinder block 11. The cylinder bores 24 are located about the rotation axis of the drive shaft 16 at equal angular intervals. A single-headed piston 25 is reciprocally housed in each cylinder bore 24. The openings of each cylinder bore 24 are closed by the valve plate assembly 13 and the corresponding piston 25. A compression chamber is defined inside each cylinder bore 24. The volume of each compression chamber changes as the corresponding piston 25 reciprocates. Each piston 25 is coupled to the peripheral portion of the swash plate 20 by a pair of shoes 26. When the swash plate 20 is rotated by rotation of the drive shaft 16, the shoes 26 converts the rotation into reciprocation of each piston 25.

In this embodiment, the drive shaft 16, the lug plate 19, the swash plate 20, the hinge mechanism 21, the pistons 25, and the shoes 26 form a piston type compression mechanism.

A suction chamber 27 and a discharge chamber 28, which surrounds the suction chamber 27, are defined between the valve plate assembly 13 and the rear housing member 11. The valve plate assembly 13 has suction ports 29, suction valve flaps 30, discharge ports 31 and discharge valve flaps 32. Each set of the suction port 29, the suction valve flap 30, the discharge port 31 and the discharge valve flap 32 corresponds to one of the cylinder bores 24. The suction chamber 27 is communicated with each cylinder bore 24 via the corresponding suction port 29. The discharge chamber 28 is communicated with each cylinder bore 24 via the corresponding discharge port 31.

When each piston 25 moves from the top dead center position to the bottom dead center position, refrigerant gas is drawn into the corresponding compression chamber through the corresponding suction port 29 while flexing the suction valve flap 30 to an open position. When each piston 25 moves from the bottom dead center position to the top dead center position, refrigerant gas in the corresponding compression chamber is compressed to a predetermined pressure and is discharged to the discharge chamber 28 through the corresponding discharge port 31 while flexing the discharge valve flap 32.

The suction chamber 27 is connected to the discharge chamber 28 by an external refrigerant circuit (not shown). Refrigerant that is discharged from the discharge chamber 28 flows into the external refrigerant circuit. The external refrigerant circuit performs heat exchange using refrigerant. When discharged from the external refrigerant circuit, the refrigerant is drawn into the suction chamber 27. Then, the refrigerant is drawn into each cylinder bore 24 to be compressed again.

A bleed passage 33 is formed in the housing to connect the crank chamber 15 with the suction chamber 27. A supply passage 34 is formed in the housing to connect the discharge chamber 28 with the crank chamber 15. A control valve 35 is located in the supply passage 34 to regulate the opening degree of the supply passage 34.

The opening of the control valve 35 is adjusted to control the flow rate of highly pressurized gas supplied to the crank chamber 15 through the supply passage 34. The pressure in the crank chamber 15 (crank chamber pressure Pc) is determined by the ratio of the gas supplied to the crank chamber 15 through the supply passage 34 and the flow rate of refrigerant gas conducted out from the crank chamber 15 through the bleed passage 33. The difference between the crank chamber pressure Pc and the pressure in the compression chambers with the pistons 25 in between is changed according to the crank chamber pressure Pc, which alters the inclination angle of the swash plate 20. As a result, the stroke of each piston 25, that is, the discharge displacement, is controlled.

As shown in FIGS. 1 to 2(b), the cylindrical support 40 protrudes from the front wall of the front housing member 12 and surrounds the front portion of the drive shaft 16. The axis of the support cylinder 40 substantially coincides with the axis of the drive shaft 16.

A lip seal 41 is located in the support cylinder 40 to fill the space between the support cylinder 40 and the drive shaft 16. The lip seal 41 prevents refrigerant from escaping the crank chamber 15 through the space between the cylindrical support 40 and the drive shaft 16.

A torque receiving member 42 is fixed to the front end of the drive shaft 16. The torque receiving member 42 is located outside of the housing and rotates integrally with the drive shaft 16. The torque receiving member 42 includes a boss 42A and a circular hub 42B. The boss 42A is fitted in the cylindrical support 40 and is located forward of the lip seal 41. The hub 42B is integrally formed with the boss 42A and is located forward of the cylindrical support 40. The hub 42B has pin supports 42c, which protrude radially outward. The number of the pin supports 42c is six in this embodiment.

The rotor, or the pulley main body 17, is fixed to the outer surface of the torque receiving member 42. The pulley main body 17 is made of a thermosetting resin such as phenol resin. The pulley main body 17 has a belt receiving portion 17A, about which is the belt 18 is hooked. The belt 18 transmits power (torque) of the output shaft of the engine E to the pulley main body 17.

The pulley main body 17 also has an inner cylinder 17B. A substantially cylindrical metal collar 43 is integrated with inner portion of the inner cylinder 17B by insert molding. A flange 43A is formed at the rear end of the metal collar 43. The flange 43A protrudes radially inward.

A radial bearing 40A is located between the metal collar 43 and the cylindrical support 40. That is, the pulley main body 17 is rotatably supported by the housing. The pulley main body 17 rotates relative to the drive shaft 16 and the torque receiving member 42. The rotation axis of the pulley main body 17 is coaxial with those of the drive shaft 16 and the torque receiving member 42. The radial bearing 40A is inserted into the metal collar 43 from the front opening. Specifically, the radial bearing 40A is press fitted to the collar 43 such that the rear end of the bearing 40A contacts the flange 43A.

Damper receptacles 17C, the number of which is six in this embodiment, are formed in the pulley main body 17 between the belt receiving portion 17A and the inner cylinder 17B. Only one of the damper receptacles 17C is shown in FIGS. 1 and 2(b). The front end of each damper receptacle 17C is open. The damper receptacles 17C are arranged in the circumferential direction of the pulley main body 17 at equal angular intervals.

A tubular elastic member (shock absorbing member), which is a rubber damper 44 in this embodiment, is fitted in each damper receptacle 17C. The rubber dampers 44 have circular cross-sections. The outer surface of each rubber damper 44 closely contacts the inner surface of the corresponding damper recess 17C.

Each damper 44 has a hole 44A, the cross-section of which is substantially circular. A power transmission pin 45 is fitted to each hole 44A. Each power transmission pin 45 is fixed to the corresponding pin support 42C of the hub 42B. Each pin 45 is press fitted in a hole formed in the corresponding pin support 42C and extends along the axial direction of the torque receiving member 42.

Power transmitted from the engine E to the pulley main body 17 is transmitted to the torque receiving member 42 through the rubber dampers 44 and the power transmission pins 45. The rubber dampers 44 and the power transmission pins 45 are located in the power transmission path between the pulley main body 17 and the torque receiving member 42.

Roller receptacles 17D, the number of which is six in this embodiment, are formed in the pulley main body 17 between the belt receiving portion 17A and the inner cylinder 17B. Only one of the roller receptacles 17D is shown in FIGS. 1 and 2(b). The rear end of each roller receptacle 17D is opened. A roller 46, which will be discussed below, is located in each roller receptacle 17D. The roller receptacles 17D are angularly spaced at the constant intervals in the circumferential direction of the pulley main body 17. Each roller receptacle 17D is located between one of the adjacent pairs of the damper receptacles 17C.

A roller guide surface 17E is formed in each roller receptacle 17D. The cross-section of each roller guide surface 17E is arcuate in a plane perpendicular to the rotation axis of the pulley main body 17. Each roller guide surface 17E forms a part of an imaginary cylinder, the axis of which is parallel to the rotation axis of the pulley main body 17. The radius of the imaginary cylinder is represented by r1, and the axis of the imaginary cylinder is spaced from the rotation axis of the pulley main body 17 by a distance R1.

A weight, which is a roller 46 in this embodiment, is accommodated in each roller receptacle 17D. The rollers 46 are made of rigid material. The diameter of each roller 46 is represented by d₁. The weight of each roller 46 is represented by m₁. Each roller 46 is accommodated in the corresponding roller receptacle 17D to roll along the roller guide surface 17E in the circumferential direction of the roller guide surface 17E.

An annular lid 47 is fixed to the rear face of the pulley main body 17 by bolts. The lid 47 covers the roller receptacles 17D to prevent the rollers 46 from falling off the receptacles 17D. Like the pulley main body 17, the lid 47 is made of a thermal setting resin such as phenol resin in this embodiment.

In this embodiment, the pulley main body 17, the metal collar 43, the rubber dampers 44, the rollers 46 and the lid 47 form a rotor.

When the rotary machine main body C is being driven by the engine E, or when the drive shaft 16 is rotating, centrifugal force causes each roller 46 to contact the corresponding guide surface 17E (see FIGS. 1 to 2(b)). If torque fluctuation is generated due to, for example, torsional vibrations of the drive shaft 16, each roller 46 starts reciprocating along the guide surface 17E of the corresponding receptacle 17D.

That is, each roller 46, or the center of gravity of each roller 46, swings like a pendulum about the axis of an imaginary cylinder that includes the corresponding guide surface 17E. That is, each roller 46 acts as a centrifugal pendulum when the rotary machine main body C is being driven by the engine E. The size and mass of the rollers 46 and the locations of the rollers 46 in the pulley main body 17 are determined such that the torque fluctuation is suppressed by pendulum motion of the rollers 46.

In this embodiment, the roller receptacles 17D of the pulley main body 17 and the rollers 46 form a dynamic damper.

The settings of the rollers 46, which function as centrifugal pendulums, will now be described.

The rollers 46 suppress torque fluctuation when the frequency of the fluctuation is equal to the characteristic frequency of the roller 46 (centrifugal pendulum). Therefore, the location, the size, and the mass of the rollers 46 are determined such that the characteristic frequency of the rollers 46 is set equal to the frequency of a peak component of the torque fluctuation. Accordingly, the amplitude of the peak component is suppressed, and the influence of the torque fluctuation is effectively reduced. Peak components of the torque fluctuation represent the peaks of the fluctuation band, or the components of rotation order.

The frequency of the torque fluctuation and the characteristic frequency of the rollers 46 are proportional to the angular velocity ω₁ of the drive shaft 16, which corresponds to the speed of the drive shaft 16. The frequency of the torque fluctuation when its band is greatest is represented by the product of the rotation speed of the drive shaft 16 per unit time (ω₁/2π) and the number N of the cylinder bore 24. That is, the frequency is represented by the formula (ω₁/2π)·N. Through experiments, it was confirmed that an nth greatest peak (n is a natural number) of the torque fluctuation has a value equal to a product n·(ω₁/2π)·N.

The characteristic frequency of the rollers 46 is obtained by multiplying the rotation speed of the drive shaft 16 per unit time (ω₁/2π) with the square root of the ratio R/r. The sign R represents the distance between the rotation axis of the pulley main body 17 (a rotor having weights that swing like pendulums) and the axis of the pendulum motion of each roller 46. The sign r represents the distance between the center of the pendulum motion of each roller 46 and the center of gravity of the roller 46.

Therefore, by equalizing the square root of the ratio R/r with the product n·N, the characteristic frequency of each roller 46 is equalized with the frequency of the nth greatest peak of the torque fluctuation. Accordingly, the torque fluctuation at the nth greatest peak is suppressed.

To suppress the greatest peak of the torque fluctuation, the values of the distances R and r are determined such that the square root of the ratio R/r is equal to N, or the value of the product n·N when n is one.

The torque produced about the rotation axis of the pulley main body 17 by the rollers 46 is represented by a sign T. To effectively reduce peaks of the torque fluctuation by the pendulum motion of the rollers 46, the torques T need to counter the torque fluctuation, and the amplitudes of the torques T need to be equal to the amplitude of the peaks of the fluctuation. When the frequency of the peak of the torque fluctuations is equal to the characteristic frequency of the rollers 46, the torque T is represented by the following equation.

T=m·(ωₐ)²·(R+r)·R·φ (Equation 1)

In the equation 1, the sign m represents the total mass of the rollers 46 (m=6m₁), and the sign ωₐ is the average angular velocity of the rollers 46 when the rollers 48 swing in a minute angle φ.

In this embodiment, the mass m is maximized to minimize the values R, r, and φ, so that the size of the pulley main body 17 is minimized, and the torque T is maximized.

The axis of each imaginary cylinder, which includes one of the guide surfaces 17E, coincides with the axis, or the fulcrum, of the pendulum motion of the corresponding roller 46. That is, the distance R1 between the rotation axis of the pulley main body 17 and the axis of each imaginary cylinder corresponds to the distance R.

The distance between the axis of the pendulum motion of each roller 46 and the center of gravity of the roller 46 is equal to the value obtained by subtracting the half of the diameter d₁, of the roller 46 from the radius r₁, of the corresponding imaginary cylinder. That is, the difference (r₁−(d₁/2)) corresponds to the distance r.

To suppress the greatest peak of the torque fluctuation, the values of the distances R₁, r₁, and the diameter d₁ are determined such that the square root of R₁/(r₁−(d₁/2), which corresponds to the square root of the ratio R/r, is equal to N, or the value of the product n·N when n is one.

The settings are determined by regarding each roller 46 as a particle at the center of gravity.

The operation of the rotary machine main body C will now be described.

When the power of the engine E is supplied to the drive shaft 16 through the pulley main body 17, the swash plate 20 rotates integrally with the drive shaft 16. As the swash plate 20 rotates, each piston 25 reciprocates in the associated cylinder bore 24 by a stroke corresponding to the inclination angle of the swash plate 20. As a result, suction, compression and discharge of refrigerant gas are repeated in the cylinder bores 24.

If the opening degree of the control valve 35 is decreased, the flow rate of highly pressurized gas supplied to the crank chamber 15 from the discharge chamber 28 through the supply passage 34 is decreased. Accordingly, the crank chamber pressure Pc is lowered and the inclination angle of the swash plate 20 is increased. As a result, the displacement of the rotary machine main body C is increased. If the opening degree of the control valve 35 is increased, the flow rate of highly pressurized gas supplied to the crank chamber 15 from the discharge chamber 28 through the supply passage 34 is increased. Accordingly, the crank chamber pressure Pc is raised and the inclination angle of the swash plate 20 is decreased. As a result, the displacement of the rotary machine main body C is decreased.

During rotation of the drive shaft 16, the compression reaction force of refrigerant and reaction force of reciprocation of the pistons 25 are transmitted to the drive shaft 16 through the swash plate 20 and the hinge mechanism 21, which torsionally (rotationally) vibrates the drive shaft 16. The torsional vibrations generate torque fluctuation. The torque fluctuation causes the rotary machine main body C to resonate. The torque fluctuations also produce resonance between the rotary machine main body C and external devices (the engine E and auxiliary devices), which are connected to the pulley main body 17 by the belt 18.

When the torque fluctuations are generated, the rollers 46 in the pulley main body 17 start swinging like pendulums. The pendulum motion of the rollers 46 produces torque about the rotation axis of the pulley main body 17. The produced torque suppresses the torque fluctuation. The characteristic frequency of the rollers 46 is equal to the frequency of the greatest peak of the torque fluctuations. Therefore, the peak of the torque fluctuations is suppressed, which effectively reduce the torque fluctuations of the pulley main body 17.

Since the pulley main body 17 is coupled to the drive shaft 16 (the torque receiving member 42) by the rubber damper 44, torque fluctuation transmitted from the torque receiving member 42 to the pulley main body 17 is attenuated. As a result, vibration such as the resonance produced by the torque fluctuation is effectively suppressed.

The rotation axes of the pulley main body 17 and the torque receiving member 42 may be displaced from each other. However, since the rubber dampers 44 are located between the pulley main body 17 and the torque receiving member 42, stress applied to the radial bearings 12A, 40A due to the displacement of the axes is reduced.

The rubber dampers 44 function effectively when the frequency of the torque fluctuation is relatively high. The rollers 46 function effectively when the frequency of the torque fluctuation is relatively low.

In this embodiment, the pulley main body 17 and the lid 47 are mad of resin. Thus, compared to a case where a pulley main body and a lid are made of metal, this embodiment reduces the noise produced when the rollers 46 collide with the pulley and the lid.

The present embodiment has the following advantages.

(1) The rollers 46 are provided in the pulley main body 17. Each roller 46 swings like a pendulum about its axis, which is spaced from the rotation axis of the pulley main body 17 by the predetermined distance R1 and is parallel to the rotation axis of the pulley main body 17. The pendulum motion of the rollers 46 suppresses the torsional vibration (the torque fluctuation), which suppresses resonance produced in the power transmission mechanism PT and the rotary machine main body C, which includes the power transmission mechanism PT. Further, the pendulum motion suppresses vibration such as the resonance produced between the rotary machine main body C and the external devices that are coupled to the pulley main body 17 by the belt 18.

(2) The pulley main body 17, which has the dynamic damper, and the lid 47 are made of resin. Therefore, compared to a case where a pulley and a lid are made of metal, the noise produced when the rollers 46 collide with the pulley and the lid. Also, compared to a case where at least one of a pulley and a lid is made of metal, the present invention reduces the weight of the rotor.

(3) The pulley main body 17 is supported by the rotary machine main body C with the metal collar 43, which is insert molded with the pulley main body 17. Compared to a case where resin portion of a pulley is directly supported by the rotary machine main body C, this embodiment improves the durability of the part of the pulley that is engaged with the rotary machine main body C.

Since the metal collar 43 is insert molded with the pulley main body 17, the pulley main body 17 is suitable for mass production. In other words, the costs are easily reduced.

(4) The pulley main body 17 is made of thermosetting resin. Compared to a case where a pulley is made of a general thermoplastic resin, this embodiment improves the strength of the pulley under high temperatures.

(5) The rollers 46 (weights) are accommodated in the roller receptacles 17D formed in the pulley main body 17. Each roller 46 moves along the arcuate guide surface 17E of the corresponding receptacle 17D, or swings like a pendulum. Therefore, the weights need not be fixed to fulcrums to be swung like pendulums. Thus, compared to a structure in which weights are fixed to fulcrums, this embodiment simplifies the structure. In a structure in which the weights are fixed to the fulcrums, the distance between each weight and the corresponding pendulum axis (fulcrum) varies due to space created between the fulcrum and the hole formed in the weight for receiving the fulcrum. The structure of the above embodiment has no such drawback. Therefore, the vibration is effectively suppressed.

(6) The rubber dampers 44 are located in the power transmission path between the pulley main body 17 and the torque receiving member 42, which attenuates the torque fluctuation transmitted from the torque receiving member 42 to the pulley main body 17. That is, in addition to the rollers 46, the rubber dampers 44 function as dampers. Therefore, resonance produced between external devices and the compressor is effectively reduced.

(7) Radial stress is applied to the drive shaft 16 due to the tension of the belt 18 coupling the pulley main body 17 with the engine E. However, since the pulley main body 17 is supported by the housing, radial stress applied to the drive shaft 16 is reduced compared to a structure in which a pulley is directly fixed to a drive shaft.

(8) The dampers 44 are located between the pulley main body 17 and the torque receiving member 42, or in the power transmission path in between. The rotation axes of the pulley main body 17 and the torque receiving member 42 may be displaced from each other due to errors. However, deformation of the rubber dampers 44 reduces stress applied to the radial bearings 12A, 40A due to the displacement of the axes. Therefore, the durability of the rotary machine, which has the power transmission mechanism PT and the rotary machine main body C, is improved.

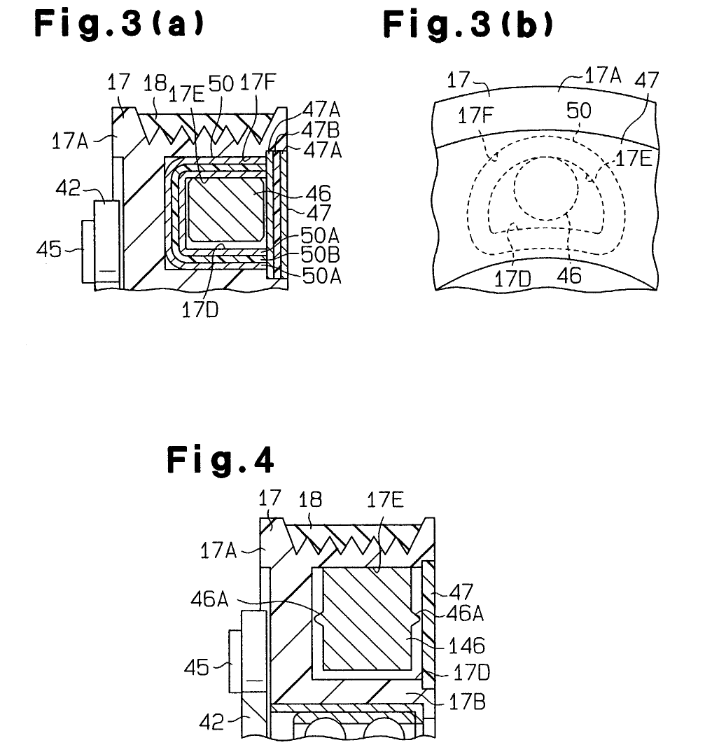

The second embodiment of the present invention will now be described with reference to FIGS. 3(a) and 3(b). The second embodiment is the same as the embodiment of FIGS. 1 to 2(b), except for the structure of the pulley main body 17. Mainly, the differences from the embodiment of FIGS. 1 to 2(b) will be discussed below, and same or like reference numerals are given to parts that are the same as or like corresponding parts of the first embodiment.

Rear recesses 17F are formed in the rear side of the pulley main body 17. Only one of the rear recesses 17F is shown in FIGS. 3(a) and 3(b). An integrally formed receptacle member 50 is fitted in each rear recess 17F. Each receptacle member 50 is formed with a vibration suppressing metal plate, which is a steel plate unit in this embodiment. The outer surface of each receptacle member 50 closely contacts the inner surface of the corresponding rear recess 17F. In this embodiment, the roller receptacles 17D for accommodating the rollers 46 are defined by the receptacle member 50.

The receptacles 50 are cup-shaped and have opened rear end when fitted in the rear recesses 17F. The receptacle members 50 are formed by drawing the plate units. As shown in FIG. 3(a), part of the inner surface of each receptacle member 50 functions as the roller guide surface 17E. The size of the rear recesses 17F is greater than that of the roller receptacles 50 by the thickness of the steel plate units forming the receptacle members 50. In FIGS. 3(a) and 3(b), the sizes of the roller receptacle 17D and the roller 46 relative to the size of the pulley main body 17 are drawn smaller compared to that in FIGS. 1 to 2(b) for purposes of illustration.

In this embodiment, an annular lid 47 is formed with another vibration suppressing steel plate unit. The annular lid 47 prevents the rollers 46 from coming off the roller receptacles 17D. Each steel plate unit for the receptacle members is formed by laminating two steel plates 50A and a resin layer 50B located between the steel plates 50A. Likewise, the steel plate unit for the lid 47 is formed by laminating two steel plates 47A and a resin layer 47B located between the steel plates 47A. The resin for the resin layers 47B, 50B has viscoelasticity that effectively attenuates vibration. Each resin layer 47B, 50B are significantly thinner than the corresponding steel plates 47A, 50A. In FIGS. 3(a) and 3(b), the resin layers 47B, 50B are depicted thicker than the actual thickness for purposes of illustration. Likewise, the steel plates 47A, 50A are depicted thicker than the actual thickness.

FIGS. 3(a) and 3(b) show a state in which the roller 46 contacts the roller guide surface 17E due to centrifugal force generated by rotation of the pulley main body 17.

In addition to the advantages (1) and (3) through (8), the second embodiment has the following advantages.

(9) The roller receptacles 17D and the lid 47 are made of the vibration suppressing steel plate units. Therefore, compared to a case where ordinary steel having no vibration suppressing property is used for roller receptacles and a lid, the noise produced when the rollers 46 collide with the roller receptacles and the lid is reduced.

(10) The pulley main body 17 is made of resin. Compared to a case where the pulley is made of metal, the present invention reduces the weight of the rotor.

It should be apparent to those skilled in the art that the present invention may be embodied in many other specific forms without departing from the spirit or scope of the invention. Particularly, it should be understood that the invention may be embodied in the following forms.

The pulley main body 17 may be formed with thermosetting resin other than phenol resin. For example, the pulley main body 17 may be formed with unsaturated polyester resin or melamine resin.

The pulley main body 17 may be formed with thermoplastic resin other than phenol resin.

In the embodiment of FIGS. 3(a) and 3(b), the pulley main body 17 need not be formed with resin. For example, the pulley main body 17 may be formed with metal.

In the embodiment of FIGS. 1 to 2(b), the lid 47 may be formed with thermosetting resin other than phenol resin.

In the embodiment of FIGS. 1 to 2(b), the lid 47 may be formed with thermoplastic resin.

In the embodiment of FIGS. 1 to 2(b), only part of the lid 47 may be formed with resin.

In the embodiment of FIGS. 1 to 2(b), only part of the lid 47 may be formed without resin. For example, the lid 47 may be formed with metal or elastomer.

In the embodiment of FIGS. 1 to 2(b), the lid 47 may be formed with a vibration suppression metal plate such as a vibration suppressing steel plate unit. The vibration suppressing metal plate may be formed by laminating two metal plates and a shock absorbing material between the metal plates. The shock absorbing material may be resin layer. The resin layer needs to have viscoelasticity that effectively attenuates vibration. Compared to a case in which a lid is made of an ordinary metal having no vibration suppressing property, the lid 47 reduces noise produced when the rollers 46 collide with the lid 47.

In the embodiment of FIGS. 3(a) and 3(b), only part of the lid 47 may be formed with vibration suppressing metal plate.

In the embodiment of FIGS. 3(a) and 3(b), the lid 47 need not be formed with a vibration suppressing metal plate. For example, the lid 47 may be formed of ordinary metal that has no vibration suppressing property. Also, the lid 47 may be formed of a vibration suppressing alloy, which has vibration suppressing property. Further, the lid 47 may be formed of resin or elastomer. If the lid 47 is made of resin, the resin may be a thermosetting resin other than phenol resin. Alternatively, the resin may be a thermoplastic resin.

In the embodiment of FIGS. 3(a) and 3(b), only part of the inner surface of each roller receptacle 17D may be formed with vibration suppressing metal plate. In this case, the entire roller guide surface 17E may be formed of a vibration suppressing metal plate or part of the roller guide surface 17E may be formed of a vibration suppressing metal plate. At least part of the inner surface of each roller receptacle 17D other than the roller guide surface 17E may be formed of vibration suppressing metal plate.

In the embodiment of FIGS. 3(a) and 3(b), the receptacle members 50 need not be formed with a vibration suppressing metal plate. For example, the receptacle members 50 may be formed of ordinary metal that has no vibration suppressing property. Also, the receptacle members 50 may be formed of a vibration suppressing alloy, which has vibration suppressing property. Further, the receptacle members 50 may be formed of resin or elastomer. If the receptacle members 50 are made of resin, the resin may be a thermosetting resin other than phenol resin. Alternatively, the resin may be a thermoplastic resin. If the receptacle members 50 are formed without vibration suppressing metal plates, at least part of the lid 47 is formed with vibration suppressing metal plate.

In the embodiment of FIGS. 3(a) and 3(b), the receptacle members 50 may be omitted and the roller receptacles may be directly formed in the pulley main body 17. In this case, the pulley main body 17 may be formed of any one of resin, elastomer, and metal. If the roller receptacles are directly formed in the pulley main body 17, at least part of the lid 47 is made of a vibration suppressing metal plate.

The metal used in the vibration suppressing metal plate units may be a metal other than steel. For example, aluminum plates or copper plates may be used in the vibration suppressing metal plate units.

Each vibration suppressing metal plate may have two-layer structure. That is, each vibration suppressing metal plate may be formed by laminating a single metal plate and a single resin layer. For a sufficient vibration suppressing property, the resin layer of a two-layer metal plate unit must be significantly greater than that of a three-layer metal plate unit. Therefore, to make a thin metal plate unit thinner, a three-layer structure is preferable.

The shock absorbing material in each vibration suppressing metal plate unit may be mad of material other than resin. For example, rubber or elastomer may be used as shock absorbing material.

In the embodiment of FIGS. 1 to 2(b), the metal collar 43 is fixed to the pulley main body 17 through insert molding. However, the metal collar 43 may be fixed to the pulley main body 17 through other methods. For example, the collar 43 may be press fitted to or adhered to the pulley main body 17.

In the embodiments of FIGS. 1 through 3(b), the outer ring of the radial bearing 40A may be directly attached to the pulley main body 17 without the metal collar 43 in between. In this case, part of the pulley main body 17 that contacts the outer ring of the radial bearing 40A needs to have sufficient strength and durability.

In the embodiment of FIGS. 3(a) and 3(b), each roller receptacle 17D need not be defined by the integrally formed receptacle member 50. Each roller receptacle 17D may be defined by two or more vibration suppressing metal plates.

In the embodiment of FIGS. 1 to 2(b), a dynamic damper having weights that swing like pendulums may be provided in the torque receiving member 42 instead of the pulley main body 17. In this case, the torque receiving member 42 is formed of resin. Also, the torque receiving member 42 forms the rotor main body. Alternatively, each of the pulley main body 17 and the torque receiving member 42 may have a dynamic damper.

In the embodiment of FIGS. 3(a) and 3(b), the roller receptacle, which forms the dynamic damper, may be formed in the torque receiving member 42 instead of the pulley main body 17. In this case, the torque receiving member 42 forms the rotor main body. Alternatively, each of the pulley main body 17 and the torque receiving member 42 may have the roller receptacles.

As in an embodiment shown in FIG. 4, a weight 146 may have axial projections 46A. In this case, if the weight 146 moves in the axial direction, the projections 46A contacts the inner walls of the receptacle 17D or the lid 47. Therefore, compared to a case where there is no axial projections like projections 46A and the entire axial surfaces of the weight 146 contact the inner walls when the weight moves axially, the weight 146, which has the projections 46A, contacts the inner walls at smaller areas and produces less noise. The embodiment of FIG. 4 may be applied to the embodiment of FIGS. 3(a) and 3(b).

A friction reducing member may be provided on at least one of the surface of each roller 46 or each weight 146 and the inner wall of the receptacle 17D to reduce friction resistance between the surface of each roller 46 or each weight 146 and the inner wall of the receptacle 17D. The friction reducing member may be a coating made of material having low coefficient of friction, such as fluorocarbon resin, formed on the surface and the inner wall. Alternatively, the friction reducing member may be liquid material having low coefficient of fiction applied to the surface and the inner wall.

In the illustrated embodiment, the rollers 46 and the weights 146 may be replaced with spherical members.

In the illustrated embodiment, the number of receptacles 17D may be changed. The number of the receptacles 17D need not correspond to the number of the cylinder bores of the rotary machine main body C.

In the illustrated embodiments, the cross-sectional shape of each receptacle 17D along a plane perpendicular to the rotation axis of the pulley main body 17 may be circular. In this case, machining of the receptacles 17D (machining of the receptacle members 50 and the rear recesses 17F in the embodiment of FIGS. 3(a) and 3(b)) is facilitated.

In the illustrated embodiments, the square root of the ratio R/r is equal to N, which is the value of n·N when the n is one. However, the square root of the ratio R/r may be the value of n·N when n is a natural number (for example two or three) that is greater than one.

In the illustrated embodiments, the ratio R/r, or the square root of the ratio R/r, of the rollers 46 (weights 146) may be different. Since there is two or more values of the ratios R/r, the bands of two or more peaks (rotation order) of the torque fluctuation are suppressed. In this case, the values n are preferably selected from numbers in order from one. For example, when three numbers are selected, one, two and three are preferably used. Accordingly, the square roots of the ratios R/r correspond to the numbers represented by the products n·N, in which the value n is one, two and three. Therefore, the three greatest peaks of the torque fluctuation are suppressed. That is, the resonance is effectively suppressed.

In the illustrated embodiments, the guide surface 17E is formed in each of the receptacle 17D in the pulley main body 17, and each roller 46 (weight 146) swings like a pendulum along the corresponding guide surface 17E. However, the pulley may have weights each of which is coupled to a fulcrum pin fixed to the pulley and swings like a pendulum. Alternatively, each weight may have a fulcrum pin, which is engaged with a hole formed in the pulley. In this case, each weight swings like a pendulum about the pin. When each weight swings at an excessively great amplitude, the weight contacts parts of the pulley. These parts of the pulley may be formed of vibration suppressing metal plate unit, which reduces noise produced due to collision of the weight against the pulley. If the pulley is formed of resin, noise produced due to collision of weights against the pulley is reduced.

In the illustrated embodiments, the settings are determined by regarding each weight as a particle at the center of gravity. However, the settings are preferably determined by taking the inertial mass of each weight into consideration. For example, in the case of the rollers 46, the settings are preferably made based on the ratio 2R/3r instead on the ratio R/r to take the inertial mass into consideration. When the frequency of the peak of the torque fluctuation is equal to the characteristic frequency of the rollers 46, the torque T is represented by the following equation.

T=(3/2)·m·(ωₐ)²·(R+r)·R·φ (Equation 2)

If spherical weights are used, the settings are preferably made based on the ratio 5R/7r to take the inertial mass into consideration. When the frequency of the peak of the torque fluctuation is equal to the characteristic frequency of the spherical weights, the torque T is represented by the following equation.

T=(7/5)·m·(ωₐ)²·(R+r)·R·φ (Equation 3)

If the weights are not formed cylindrical or spherical, the settings are preferably made by taking the inertial mass of the weights into consideration so that the resonance is effectively suppressed.

The rubber dampers 44 need not have circular cross-section.

Dampers made of elastomer may be used.

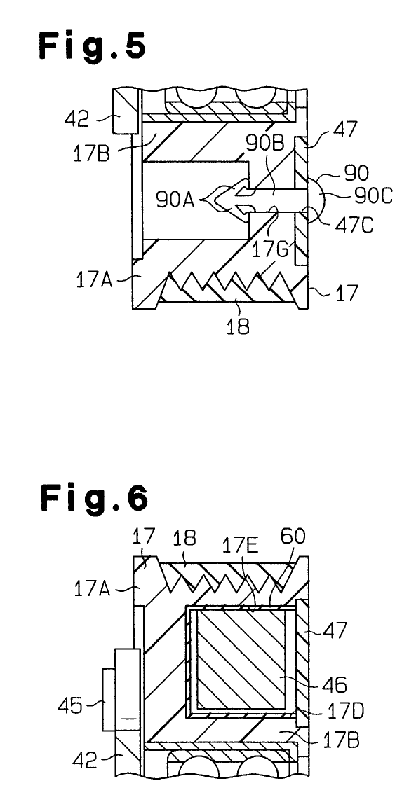

In the illustrated embodiment, the lid 47 may be fixed to the pulley main body 17 by a member other than screws. For example, crimping pins or press fitting pins may be used. Such pins are inserted into holes formed in the lid 47 and corresponding holes formed in the pulley main body 17. An end of a crimping pin is crimped so that it does not escape the corresponding holes. A press fitting pin is press fitted into the corresponding holes. For example, in an embodiment illustrated in FIG. 5, a pin 90 having an elastic portion 90A may be used. A hole 47C is formed in the lid 47 and a hole 17G is formed in the pulley main body 17 to correspond to the hole 47C. The diameter of the hole 47C is substantially the same as that of the hole 17G. The pin 90 has a cylindrical main portion 90B, the outer diameter of which is substantially the same as the inner diameter of the holes 17G, 47C. A head 90C, the diameter of which is greater than the inner diameter of the hole 47C is formed integrally with the main portion 90B at one end. Engaging pieces 90A (only two of them are shown in FIG. 5) are formed integrally with the main portion 90B at the other end of the main portion 90B. In the normal state, each engaging piece 90A is tapered toward the distal end. In this state, the distal end of each engaging portion 90A is radially outward of the opening of the hole 17G. Therefore, the engaging portions 90A and the head 90C prevent the pin 90 from escaping the holes 17G, 47C, and the lid 47 is secured to the pulley main body 17. The engaging portions 90A can be elastically deformed by external force. When the engaging portions 90A are deformed, the proximal ends are radially inward of the openings of the holes 17G, 47C. That is, the pin 90 can be inserted into and removed from the holes 17G, 47C by deforming the engaging portions 90A. When securing the lid 47 to the pulley main body 17 by using the pin 90, the pin 90 need not be rotated or crimped. This facilitates the installation.

As a modification of the embodiment of FIGS. 1 to 2(b), an elastic film 60 such as a rubber film may be provided on the inner surface of each roller receptacle 17D (see FIG. 6). The elastic films further reduce noise produced when the rollers 46 collide with the inner surfaces of the roller receptacles 17D.

The power transmission mechanism PT need not be supported by the housing. Instead, the power transmission mechanism PT may have a rotor that is fixed to the drive shaft 16 and coupled to external devices.

The number of cylinder bores 24 in the rotary machine main body C may be changed.

The power transmission mechanism PT may be used for a double-headed piston type compressor. In a double-headed piston type compressor, two compression chambers are defined in each cylinder bore at both ends of the corresponding piston.

The rotary machine main body C may be a wobble plate type compressor, in which a drive plate is rotatably supported by a drive shaft.

The rotary machine main body C may be a fixed displacement type compressor, in which the stroke of the pistons are not variable.

The present invention may be applied to a scroll-type compressor.

A sprocket of a gear may be used as a member coupled to external devices.

The rotor may be a member that is not located in the power transmission path between an external device and a rotary machine. The present invention may be applied to any type of rotor as long as it is coupled to rotary machine even if the rotor is not located in a power transmission path.

The present invention may be applied to any rotary machine as long as a rotor connected to the machine produces rotational vibration.

In the embodiments shown in FIGS. 1 to 5, the center of swinging motion of each roller 46 and each weight 146 need not be parallel to the rotation axis of the rotor. In this case, the axis of the swinging motion may be inclined relative to the rotation axis of the rotor within a range where a predetermined torque fluctuation reduction performance is obtained.

Therefore, the present examples and embodiments are to be considered as illustrative and not restrictive and the invention is not to be limited to the details given herein, but may be modified within the scope and equivalence of the appended claims.

1. A rotor connected to a main body of a rotary machine, the rotor comprising:
a rotor main body made of resin; and
a dynamic damper provided in the rotor main body, wherein the dynamic damper has a weight that swings like a pendulum, wherein the axis of the pendulum motion of the weight is separated by a predetermined distance from and is substantially parallel to the rotation axis of the rotor.

2. The rotor according to claim 1 further comprising a metal collar fixed to the rotor main body by insert molding of the rotor main body, wherein the rotor main body is supported by the rotary machine main body with the metal collar.

3. The rotor according to claim 1, wherein the resin is thermosetting resin.

4. The rotor according to claim 1, wherein the dynamic damper has an accommodating portion for accommodating the weight, wherein the accommodating portion is made of resin, wherein a guide surface, which has an arcuate cross-section, is formed in the accommodating portion, wherein the weight moves along the guide surface.

5. The rotor according to claim 4, wherein the accommodating portion is a recess, which is formed on the rotor main body, and wherein an elastic film is located on at least part of the inner surface of the recess.

6. The rotor according to claim 4, wherein the accommodating portion has an opening to receive the weight, wherein the opening is covered with a lid to prevent the weight from falling off the opening, and wherein at least part of the lid is made of resin.

7. The rotor according to claim 4, wherein the accommodating portion has an opening to receive the weight, wherein the opening is covered with a lid to prevent the weight from falling off the opening, and wherein at least a part of the lid is formed with a vibration suppressing metal plate.

8. The rotor according to claim 4, wherein the weight has a projection, which projects along the rotation axis of the rotor.

9. A rotor which has a rotor main body connected to a main body of a rotary machine, the rotor comprising:
a dynamic damper provided in the rotor main body, wherein the dynamic damper includes:
an accommodating portion, wherein the accommodating portion has a guide surface, wherein a cross-section of the guide surface along a plane perpendicular to the rotation axis of the rotor main body is arcuate;
a weight that swings like a pendulum, wherein the axis of the pendulum motion of the weight is separated by a predetermined distance from and is substantially parallel to the rotation axis of the rotor, wherein the accommodating portion has an opening to receive the weight; and
a lid located on the opening of the accommodating portion, and wherein at least a part of at least one of the accommodating portion and the lid is formed with a vibration suppressing metal plate.

10. The rotor according to claim 9, wherein at least a part of the guide surface is formed with the vibration suppressing metal plate.

11. The rotor according to claim 9, wherein a recess is formed in the rotor main body, and wherein the accommodating portion is formed by covering the inner surface of the recess with a single vibration suppressing metal plate, and wherein the vibration suppressing metal plate forms the guide surface.

12. The rotor according to claim 9, wherein at least a part of the lid is formed with the vibration suppressing metal plate.

13. The rotor according to claim 9, wherein the weight has a projection, which projects along the rotation axis of the rotor.

14. The rotor according to claim 9, wherein the rotor main body is made of resin.

15. A rotary machine having a rotor, the rotor comprising:
a rotor main body made of a resin; and
a dynamic damper provided in the rotor main body, wherein the dynamic damper has a weight that swings like a pendulum, wherein the axis of the pendulum motion of the weight is separated by a predetermined distance from and is substantially parallel to the rotation axis of the rotor.

16. The rotary machine according to claim 15 has a compression mechanism to compress refrigerant.
